(19) United States
(12) Patent Application Publication
(10) Pub. No.: US 2002/0094712 A1
(43) Pub. Date: Jul. 18, 2002

(54) Electrical connector and mating fitting

(76) Inventor: Tat Kwong Cheung, Kowloon (HK)

Correspondence Address: JACKSON WALKER L.L.P., Suite 2100, 112 E. Pecan Street, San Antonio, TX, 78205, US

(21) Appl. No.: 09/967,438

(22) Filed: Sep. 28, 2001

(30) Foreign Application Priority Data
Nov. 14, 2000 (HK) 00107247.6
Jan. 12, 2001 (HK) 01100347.9

(51) Int. Cl. H01R 4/50

(52) U.S. Cl. 439/346

(57) ABSTRACT

An electrical connectors connects with a mating fitting having one or more conductive pins. The connector include a housing, an carriage movably mounted within the housing, a conductive claim mounted to the carriage and including a movable portion which presses against one of the conductive pins when the connector is connected with the fitting, Hinge frictional forces need not be overcome when connecting for disconnecting the connector from the fitting.

### BACKGROUND OF THE INVENTION

Known electrical connectors for domestic appliances include plugs and sockets. These known connectors usually include two or more pins which are each received between a pair of pinching elements to provide the necessary electrical contact. This pinching interengagement requires that the conductive parts encounter sliding frictional contact during the attachment and detachment of the plug to and from the socket. A good electrical contact requires a high pressing force between the engaged conductive elements but this high engagement force must be overcome to detach the socket from plug, As a result, a dangerous situation can arise for example where a plug is received by a socket formed integrally with a kettle for example. That is, a user such as a child pulling on an electrical cord can inadvertently pull and dislodge an appliance such as a kettle of boiling water or a deep fryer and scold him or herself and/or cause a dangerous hazard as a result.

There are many other situations where the tight interengagement of an electrical plug and socket causes some disadvantage. In many instances, people simply pull the electrical cord rather than grasping the plug or socket itself and this can result in the insulation being stripped from the cord leaving exposed live conductors

### OBJECTS OF THE INVENTION

It is an object of the present invention to overcome or substantially ameliorate at least one of the above disadvantages and/or more generally to provide an improved electrical connector and mating fitting.

It is another object of the present invention to provide an electrical connector and mating fitting wherein it is not necessary to overcome frictional contact forces of electrically contacting parts when connecting or disconnecting the connector to/from the mating fitting

It is a further object of the present invention to provide an electrical connector providing good electrical contact without the need to overcome frictional contact forces between the electrically contacting parts when connecting or disconnecting the connector to/from the a matting fitting.

It is a further object of the present invention to provide an electrical socket that is pivotally connected to an appliance.

### DISCLOSURE OF THE INVENTION

There is disclosed herein an electrical connector for connection to a mating fitting having one or more conductive pins, the connector comprising:

a housing,

a carriage movably mounted within the housing,

a conductive clamp mounted to the carriage and including a movable portion which presses against one of said conductive pins when the connector is connected with the fitting.

Preferably the electrical connector of further comprises an activator mounted to the connector and pressing against the movable portion of the clamp when the connector is connected with the fitting.

Preferably the activator includes a boss extending therefrom the bear against the movable portion of the clamp.

Preferably the clamp includes a fixed portion against which the pin presses when the connector is connected with the fitting.

There is further disclose herein a combination of the above—disclosed electrical connector and a matting fitting, the mating fitting being a socket comprising a cavity into which a portion said carriage is received when the connector and fitting are connected, the fitting having a ramp surf ace inside said cavity, said activator including a cam aligned with the ramp surf ace to bear thereagainst when the connector is connected to the fitting to thereby effect said pressing of the clamp,

Preferably the carriage is slidably mounted within the housing.

Preferably the connector further includes spring means for biassing the carriage toward an extended position.

Preferably the connector is a plug at an end of an insulated conductive flexible cord having two or more conductors.

Preferably part of the cord extending into the housing acts as a spring biassing the carriage toward an extended position.

There is further disclosed herein an electrical socket comprising:

a housing,

a conductive pin shielded by the housing,

an internal electrical conductor connected to the pin,

a hinge by which the socket is pivotally attached to an electrical appliance and through which said conductor passes from the socket to the appliance.

### BRIEF DESCRIPTION OF THE DRAWINGS

A preferred form of the present invention will now be described by way of example which reference to the accompanying drawings, wherein:

FIG. 1 is a perspective view of a plug and a socket in an engaged configuration,

FIG. 2 is a perspective view of a plug and a socket in a disengaged configuration,

FIG. 3 is a schematic perspective view of the plug and socket in the configuration of FIG. 1, but having cover portions of the plug and the socket removed for illustration purposes only,

FIG. 4 is a schematic perspective view of the plug and socket in the configuration of FIG. 2, having covering portions of the plug and socket removed for illustration purposes only,

FIG. 5 is a schematic partially cross sectioned plan view of the plug and socket in a partially detached configuration with cover portion removed for illustration purposes only,

FIG. 6 is a schematic detailed illustration of the portion of the components shown at VI in FIG. 5,

FIG. 7 is a schematic partially cross sectioned plan view of the plug and socket in an attached configuration,

FIG. 8 is a schematic detailed illustration of the portion of the components indicated by VII in FIG. 7,

FIG. 9 is a schematic perspective illustration of an activator forming part of the plug illustrated in FIGS. 1 to 4,

FIG. 10 is a schematic perspective illustration of a pair of conductive clamps forming part of the plug of FIGS. 1 to 4,

FIG. 11 is a schematic parts—exploded perspective view of a socket, and

FIG. 12 is another schematic parts—exploded view of the socket of FIG. 11.

### DESCRIPTION OF THE PREFERRED EMBODIMENT

In the accompanying drawings, there is schematically depicted a plug 10 and socket 11 combination. Plug 10 and socket 11 are typically formed as a moulded dielectric material, typically a plastics moulding. Plug 10 has fitted thereto a stress—relief grommet 14 through which an electric cord 13 passed. The socket 11 includes a hinge body 16 integrally moded therewith. Extending from opposite sides of the hinge body 16 is a pair of hinge lugs 15 through one or each or which wires 12 pass. Socket 11 would typically be permanently hingedly attached to an electrical appliance such as a kettle by means of the hinge lugs 15.

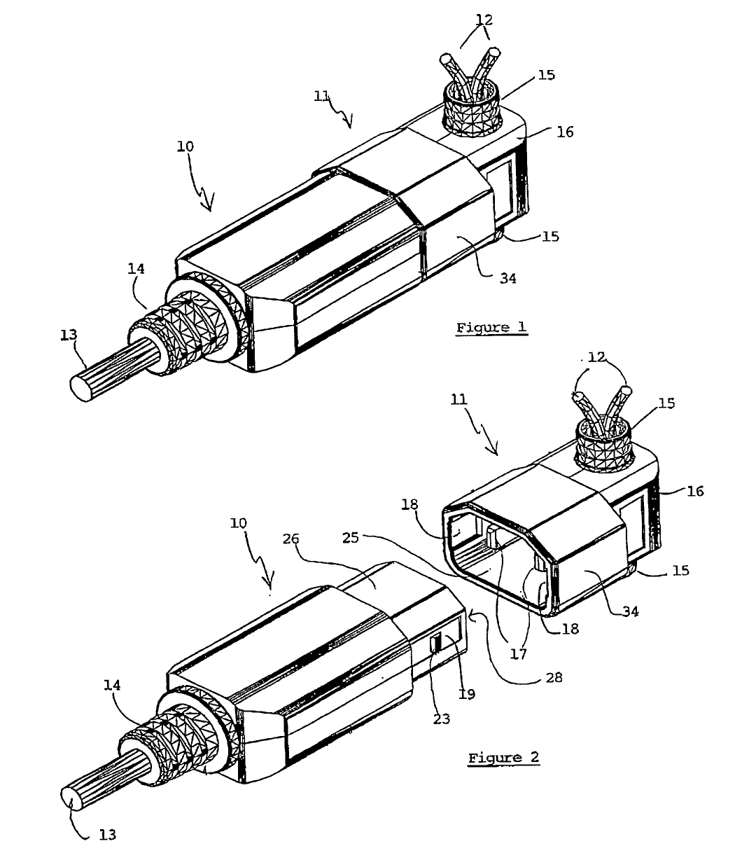

As shown in FIG. 2, the socket 11 includes a cavity 25 within which there is located a pair of electrically conductive pins 17 individually attached to respective ones of wires 12. The socket 11 includes walls 34 which protect and shield the pins 17. The side wall portions 34 each have an internally located recess 18.

Also as seen in FIG. 2, the plug 10 includes a carriage 26 that projects from the main body of the plug 10. Carriage 26 can slide within the main housing of the plug. A pair of activator arms 19 reside one at either laterally opposed side of carriage 26 and each include a propluding cam 23. Cam 23 is moulded integrally with each activator arm 19.

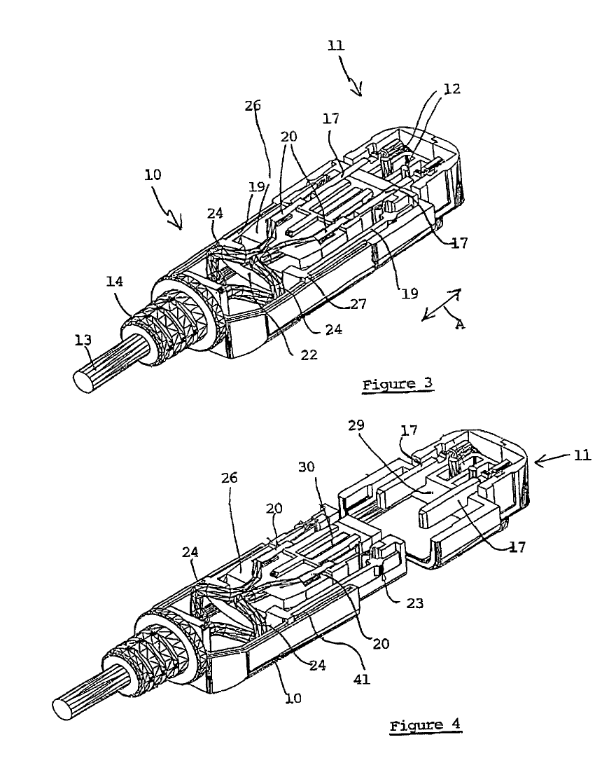

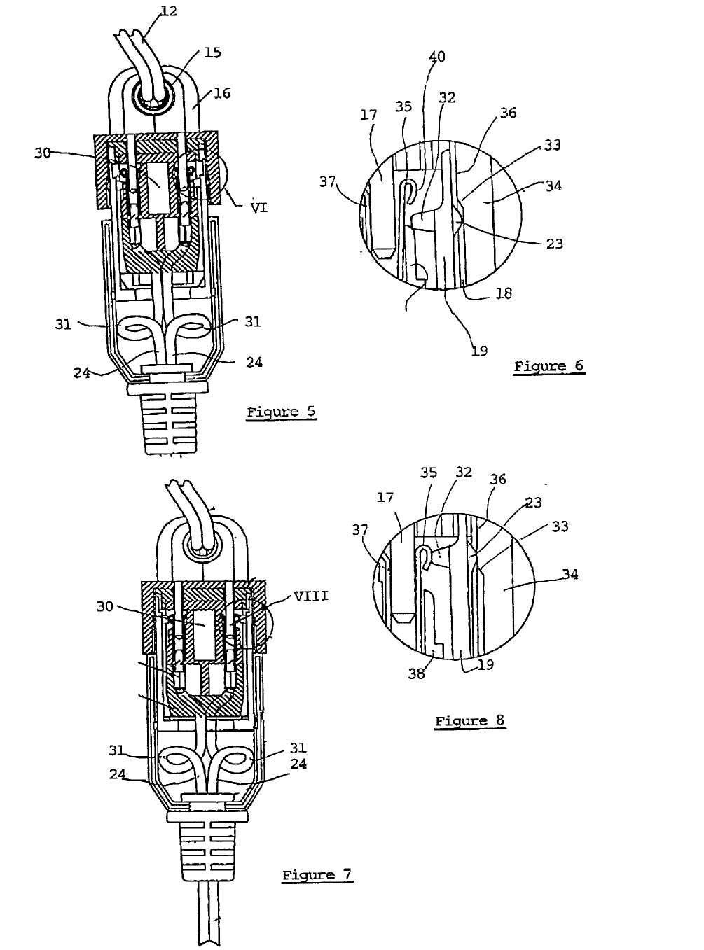

With reference to FIGS. 3 and 4, it can be seen that the cord 13 passing through gromet 14 includes a pair of wires 24 which each extend to a respective conductive clamp 20. These are better illustrated in FIG. 104 Each conductive clamp 20 is received by the carriage 26. Carriage 26 can slide in the directions indicated by arrow A in FIG. 3. The carriage 26 is biassed into the extended configuration as depicted in FIG. 7 by the resilience of wires 24 which form a coil 31 as shown in FIG. 5 and 6. That is, the electrically conductive wire itself forms a spring which pushes the carriage 26 forward.

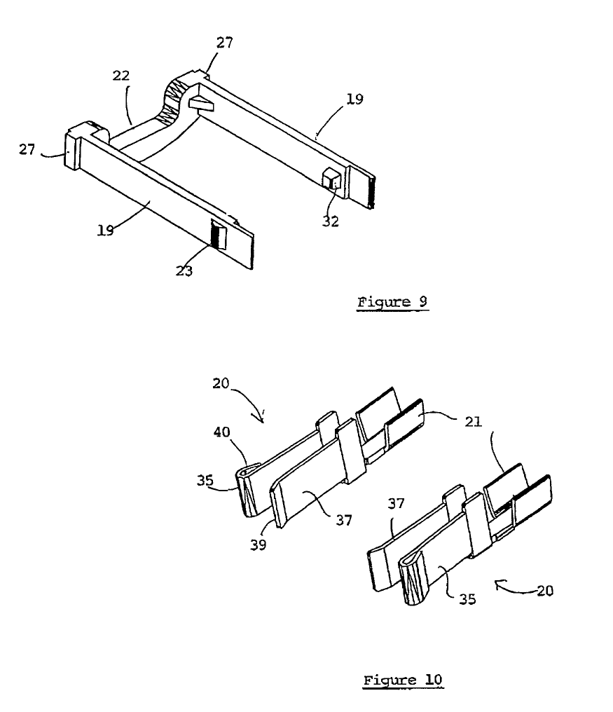

As Seen in FIGS. 3, 4, 5 and 7 and better illustrated in FIG. 9, each activator arm 19 is formed as part of a unitary structure comprising a bridge 22 from which each activator arm extends. At each lateral end of the bridge 22, there is a provided a lug 27 by which the structure is constrained within the main body of plug 10. To this end, a pair of slots 41 are formed within the moulding of plug 10. Moreover, the carriage 26 can slided relative to the activator arms 19.

The carriage 26 includes a central block 30 against which a fixed leg 37 of each clamp 20 bears.

The pins 17 are each received between a respective one of the fixed legs 37 and a movable leg 35 of each clamp 20.

As better illustrated in FIGS. 6 and 8, the activator arm 19 includes a protruding boss 32 which engages with a bearing service 40 form as a bent over portion of the movable leg 35. In order to effect movement of the boss 32 into the position depicted FIG. 8, the cam 23 must ride against a ramp service 33 formed at an inner end of recess 18 such that the cam 23 bears against a locking surface 36 formed as an inner service of side wall 34 of the socket 11.

A retainer 38 is provided alongside the movable leg 35 to define its outer most moveable extent.

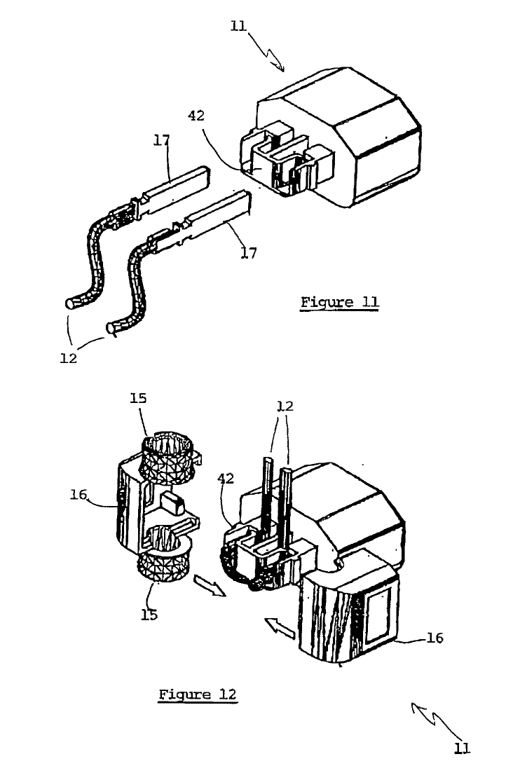

The structure of each clamp 20 will be better understood by reference to FIG. 10 which shows that the fixed leg 37 and movable leg 35 are formed from a single piece of conductive material, typically stainless steel. The clamp include crimping tabs 21 by which exploded ends of conductive wires 24 are received. These exploded end might nerely be crimped or might otherwise be soldered to or otherwise connected to the respective clamps 20.

As shown in FIGS. 11 and 12, the socket 11 has affixed thereinto the pair of pins 17 which each have crimped thereto or otherwise attached the ends of wire 12. These wires are directed through mountain block 42 so as to extend upwardly therfrom. The wires 12 pass through the upper hinge lug 15 and into an electrical appliance to which the socket 11 is pivotally attached. The hinge body 16, one half of which has integrally moulded therewith the hinge lugs 15 is snape—engaged or otherwise fitted over the mounting block 42.

In use, the plug and socket are interconnected by pushing the plug into the socket in a knowing manner. When the front face 28 of the carriage 26 engages with the back face 29 of cavity 25, the pins 17 are loosely received between the respective fixed 37 and movable 35 legs of respective clamps 20. Upon further pushing the plug 10 into the socket 11, the cams 23 bear upon ramp surfaces 33 whereupon bosses 32 bear against bearing service 40 of the respective movable legs 35 to push the movable legs down laterally upon the pins 17. There is little or no sliding frictional engagement of the pins with the clamps 20. Force apply by the boss 32 to the movable leg 35 is transferred to the pin 17 and in turn transferred from the other side of pin 17 to the fixed leg 37. A good, tight electrical interengagement is achieved without the need for sliding frictional contact between the electrically conductive elements.

When the plug is withdrawn from the socket, the cam 23 rise down ramp 33 to release boss 32 from movable leg 35 to return the component to the position depicted in FIG. 6.

By appropriate choice of materials, the frictional forces encountered between cam 23 and socket 11 as well as frictional forces encountered between boss 32 and bearing service 14 are significantly lower than those between metal—metal flexional contact required in prior art devices.

1. An electrical connector for connection to a mating fitting having one or more conductive pins, the connector comprising:
a housing,
a carriage movably mounted within the housing,
a conductive clamp mounted to the carriage and including a movable portion which presses against one of said conductive pins when the connector is connected with the fitting.

2. The electrical connector of claim 1 further comprising an activator mounted to the connector and pressing against the movable portion of the clamp when the connector is connected with the fitting.

3. The electrical connector of claim 2 wherein the activator includes a boss extending therefrom to bear against the movable portion of the clamp.

4. The electrical connector of claim 1 wherein the clamp includes a fixed portion against which the pin presses when the connector is connected with the fitting.

5. A combination of the electrical connector of claim 2 and a mating fitting, the mating fitting being a socket comprising a cavity into which a portion said carriage is received when the connector and fitting are connected, the fitting having a ramp surface inside said cavity, said activator including a cam aligned with the ramp surface to bear thereagainst when the connector is connected to the fitting to thereby effect said pressing of the clamp.

6. The connector of claim 1 wherein the carriage is slidably mounted within the housing.

7. The connector of claim 6 further including spring means for biassing the carriage toward an extended position.

8. The connector of claim 6 being a plug at an end of an insulated conductive flexible cord having two or more doncutors.

9. The connectors of claim 8 wherein part of the cord extending into the housing acts as a spring biassing the carriage toward an extended position.

10. An electrical socket comprising:
a housing,
a conductive pin shielded by the housing,
an internal electrical conductor connected to the pin,
a hinge by which the socket is pivotally attached to an electrical appliance and through which said conductor passes from the socket to the appliance.
